(19) United States
(12) Patent Application Publication
(10) Pub. No.: US 2019/0283771 A1
(43) Pub. Date: Sep. 19, 2019

(54) VEHICLE CONTROL DEVICE

(71) Applicant: Honda Motor Co.,Ltd., Tokyo (JP)

(72) Inventors: Takashi ADACHI, Saitama (JP); Masayuki SADAKIYO, Saitama (JP); Tomoyuki NOGUCHI, Saitama (JP); Hisashi ISHIKAWA, Saitama (JP); Kentaro ARAI, Saitama (JP)

(73) Assignee: Honda Motor Co.,Ltd., Tokyo (JP)

(21) Appl. No.: 16/299,150

(22) Filed: Mar. 12, 2019

(30) Foreign Application Priority Data
Mar. 16, 2018 (JP) 2018-049856

(51) Int. Cl. B60W 50/08; G05D 1/00; G05D 1/02; B60W 50/14

(52) U.S. Cl. CPC B60W 50/082; G05D 1/0088; G05D 1/0223; B60W 2540/22; B60Y 2200/92; B60W 2540/02; B60W 50/14

(57) ABSTRACT

An automated driving controller that decides an action plan for a vehicle is selectable between an ordinary driving mode and a hurried driving mode that is used in a case in which a driver is in a hurry as compared with the ordinary driving mode. In an automated driving mode the vehicle is automatically controlled, the hurried driving mode is a mode in which it is possible to arrive at a destination earlier than in the ordinary driving mode, and the driver being in a hurry appears in behaviors in the vehicles, the vehicle is accompanied with an information acquisition unit that acquires the state in which the driver is in a hurry and delivers information to the automated driving controller, and the automated driving controller selects the hurried driving mode when the information acquisition unit acquires the state in which the driver is in a hurry.

### CROSS-REFERENCE TO RELATED APPLICATION

This application claims the priority benefit of Japan application serial no. 2018-049856, filed on Mar. 16, 2018. The entirety of the above-mentioned patent application is hereby incorporated by reference herein and made a part of this specification.

### BACKGROUND

### Technical Field

The disclosure relates to a vehicle control device and particularly to a vehicle control device that performs automated driving control for a vehicle.

### Description of Related Art

In the related art, there is a vehicle control device that includes an automated driving controller that automatically controls a host vehicle such that the host vehicle travels along a route to a destination as disclosed in Patent Document 1, for example. According to the vehicle control device in such automated driving control, vehicle driving force is shifted from vehicle driving force in an automated driving mode to driving force that a driver of the vehicle requests in a manual driving mode when switching from the automated driving mode to the manual driving mode is performed during traveling of the vehicle.

Here, since the vehicle travels on the basis of a travel request in a state in which the driver is in a hurry in the manual driving mode in a case in which the driver is in a hurry, the state in which the user is in a hurry appears in behaviors of the vehicle. In this case, it is possible for the driver to recognize that the vehicle is being able to travel as the driver intends, and it is possible to alleviate irritation of the driver.

However, the state in which the driver is in a hurry does not appear in behaviors of the vehicle even if the vehicle travels on the basis of an action plan in which the shortest route is objectively selected in the automated driving mode in the related art. Therefore, there is a problem that it is not possible for the driver to recognize that the vehicle is being able to travel as the driver requests from the behaviors of the vehicle in the automated driving mode, and that it is difficult to alleviate irritation of the driver in a case in which the driver is in a hurry.

### PATENT DOCUMENTS

[Patent Document 1] Japanese Unexamined Patent Application Publication No. 2017-146819

The disclosure was made in view of the aforementioned points, and is to provide a vehicle control device that enables a driver to recognize that a vehicle is being able to travel as the driver intends from behaviors of the vehicle even in a case in which the driver is in a hurry and the vehicle is traveling by automated driving.

### SUMMARY

The disclosure provides a vehicle control device capable of performing a switching between an automated driving mode and a manual driving mode, wherein in the automated driving mode steering, acceleration and deceleration of a vehicle 1 are automatically controlled and in the manual driving mode the steering, acceleration and deceleration of the vehicle are controlled on the basis of a driver's operation, the vehicle control device including: an automated driving controller 110 that decides an action plan, in which the automated driving controller 110 is selectable between an ordinary driving mode and a hurried driving mode in which the hurried driving mode is used in a case in which the driver is in a hurry as compared with the ordinary driving mode, the hurried driving mode is a mode in which the vehicle is able to arrive at a destination earlier than in the ordinary driving mode and in which a state in which the driver is in a hurry appears in behaviors of the vehicle, the vehicle 1 is provided with an information acquisition unit 77 that acquires the state in which the driver is in a hurry and delivers information to the automated driving controller 110, and the automated driving controller 110 selects the hurried driving mode in a case in which the information acquisition unit 77 acquires the state in which the driver is in a hurry.

### BRIEF DESCRIPTION OF THE DRAWINGS

Embodiments will now be described, by way of example only, with reference to the accompanying drawings which are meant to be exemplary, not limiting, and wherein like elements are numbered alike in several figures, in which:

FIG. 1 is a functional configuration diagram of a vehicle control device according to an embodiment of the disclosure;

FIG. 2 is an outline diagram illustrating a configuration of a hybrid vehicle;

FIG. 3 is an outline explanatory diagram of an occupant information acquisition unit according to the embodiment;

FIG. 4 is a flowchart for describing control in an ordinary driving mode and a hurried driving mode; and

FIG. 5 is a timing chart comparing the hurried driving mode and the ordinary driving mode.

### DESCRIPTION OF THE EMBODIMENTS

In this manner, it is possible to arrive at the destination earlier by the automated driving controller selecting the hurried driving mode in a case in which the state in which the driver is in a hurry is acquired. Also, it is possible for the driver to recognize that the vehicle is being able to travel as the driver intends from behaviors of the vehicle by the state in which the driver is in a hurry appearing in the behaviors of the vehicle.

Also, the hurried driving mode may be set such that acceleration is higher than acceleration in the ordinary driving mode in the vehicle control device. In this manner, the state in which the driver is in a hurry appears in the behaviors of the vehicle, and it is possible to arrive at the destination earlier.

Also, the hurried driving mode may be set such that a transmission ratio is higher than a transmission ratio in the ordinary driving mode in the vehicle control device. In this manner, the state in which the driver is in a hurry appears in the behaviors of the vehicle, and it is possible to quickly respond to an acceleration request.

Also, the hurried driving mode may be set such that a time required for gear change is shorter than a time required for gear change in the ordinary driving mode in the vehicle control device. In this manner, the state in which the driver is in a hurry appears in the behaviors of the vehicle, and it is possible to shorten the time required for gear change.

Also, the hurried driving mode may be set such that more oscillation occurs during gear change than in the ordinary driving mode in the vehicle control device. In this manner, the state in which the driver is in a hurry appears in the behaviors of the vehicle.

Also, the hurried driving mode may be set such that a target vehicle speed is higher than a target vehicle speed in the ordinary driving mode in the vehicle control device. In this manner, the state in which a driver is in a hurry appears in the behaviors of the vehicle, and it is possible to arrive at the destination early.

Also, the hurried driving mode may be set such that an inter-vehicle distance is shorter than an inter-vehicle distance in the ordinary driving mode in the vehicle control device. In this manner, the state in which the drive is in a hurry appears in the behaviors of the vehicle, this leads to a decrease in time at a traffic signal or the like, for example, and it is thus possible to arrive at the destination early.

Also, the hurried driving mode may be set such that a time required for lane change is shorter than a time required for lane change in the ordinary driving mode in the vehicle control device. In this manner, the state in which the driver is in a hurry appears in the behaviors of the vehicle.

Also, the hurried driving mode may be set such that a route for an earlier destination arrival time than in the ordinary driving mode is selected in the vehicle control device. In this manner, the arrival at the destination becomes earlier.

Also, the vehicle 1 may have an internal combustion engine EG and an electric motor MT that serve as power source, and the hurried driving mode may be set such that stopping of the internal combustion engine EG is inhibited in the vehicle control device. In this manner, the state in which the driver is in a hurry appears in the behaviors of the vehicle, and it is possible to obtain a state in which maximum driving force can be output using the internal combustion engine in the hybrid vehicle.

Also, the hurried driving mode may be set such that the electric motor MT is caused to generate more power than in the ordinary driving mode in the vehicle control device. In this manner, more force is output, and the arrival at the destination becomes earlier.

Also, the information acquisition unit 77 may acquire a state in which the driver is in a hurry on the basis of an action input by the driver in the vehicle control device. In this manner, it is possible to reliably deliver the state in which the driver is in a hurry to the information acquisition unit.

Also, the information acquisition unit 77 may have an input switch 77a for inputting the state in which the driver is in a hurry, and the input action may be performed by the driver operating the input switch 77a in the vehicle control device. In this manner, it is possible to reliably deliver the state in which the driver is in a hurry to the information acquisition unit with a simple operation, namely an operation of the switch.

Also, the information acquisition unit 77 may have a voice recognition unit 77b that is able to recognize voice, and the input action may be performed by voice of the driver being recognized using the voice recognition unit 77b in the vehicle control device. In this manner, it is possible to reliably deliver the state in which the driver is in a hurry to the information acquisition unit with a driver's simple operation, namely voice generation.

Also, the information acquisition unit 77 may have a driver state acquisition unit 77c, 77d that is able to acquire a state in which the driver is in a hurry in the vehicle control device. In this manner, if the driver state acquisition unit is provided, it is possible to omit the driver's input action by automatically acquiring the state in which the driver is in a hurry.

Also, the driver state acquisition unit may be a biological signal recognition unit 77c that is able to acquire a biological signal of the driver in the vehicle control device. In this manner, it is possible to omit the driver's input action by acquiring the biological signal.

Also, the driver state acquisition unit may be a face information recognition unit 77d that is able to acquire a facial expression of the driver in the vehicle control device. In this manner, it is possible to omit the driver's input action by acquiring the facial expression.

Also, the vehicle 1 may have a notification device 82 that notifies the driver of information, and the automated driving controller 110 may provide a notification to the notification device 82 in a case in which the information acquisition unit 77 acquires a state in which the driver is in a hurry. In this manner, it is possible to for the driver to easily recognize that the vehicle is being able to travel as the driver intends in the case of the state in which the driver is in a hurry.

Note that the aforementioned reference numerals in parentheses represent reference numerals of corresponding components in embodiments, which will be described later, as examples of the disclosure.

According to the vehicle control device of the disclosure, it is possible for the driver to recognize that the vehicle is being able to travel as the driver intends from the behaviors of the vehicle even in a case in which the driver is in a hurry and the vehicle is traveling by automatic driving.

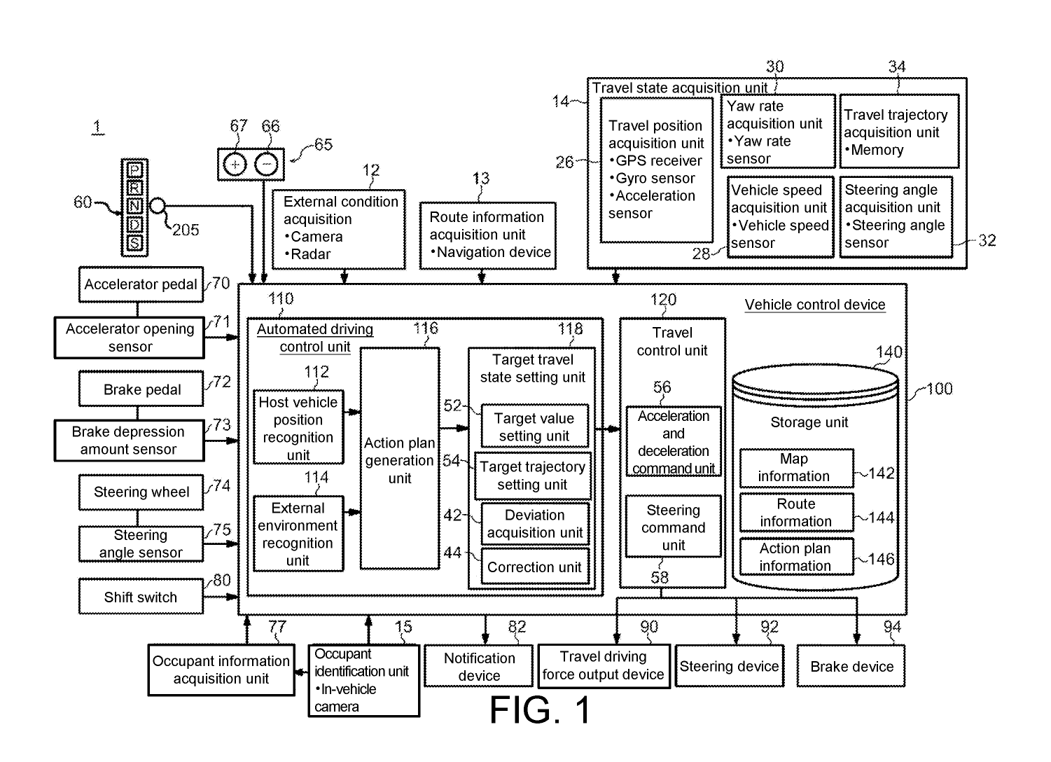

Hereinafter, embodiments of the disclosure will be described with reference to the accompanying drawings. FIG. 1 is a functional configuration diagram of a vehicle control device 100 mounted in a vehicle 1. A configuration of the vehicle control device 100 will be described using the drawing. The vehicle 1 (host vehicle) in which the vehicle control device 100 is mounted is, for example, a vehicle with two wheels, three wheels, four wheels, or the like and includes a vehicle using an internal combustion engine as a power source, an electric vehicle using an electric motor as a power source, a hybrid vehicle that includes both an internal combustion engine and an electric motor, and the like. Also, the aforementioned electric vehicle is driven using electric power discharged by a battery such as a secondary battery, a hydrogen fuel battery, a metal fuel battery, or an alcohol fuel battery, for example.

The vehicle control device 100 includes a mechanism for taking various kinds of information from the outside of the vehicle 1, such as an outer condition acquisition unit 12, a route information acquisition unit 13, and a travel state acquisition unit 14. In addition, the vehicle control device 100 includes operation devices (operation elements), to which operations are input, such as an accelerator pedal 70, a brake pedal 72, a steering wheel 74 (handle), and a shift switch 80. The vehicle control device 100 includes operation detection sensors such as an accelerator opening sensor 71, a brake depression amount sensor 73, and a steering angle sensor 75 (or a steering torque sensor), a notification device 82, and an occupant identification unit 15 (in-vehicle camera). Also, the vehicle control device 100 includes a travel driving force output device 90, a steering device 92, and a brake device 94 as devices for driving or steering the vehicle 1.

These devices and equipment are connected to each other via multiple communication lines such as controller area network (CAN) communication lines, serial communication lines, a wireless communication network, or the like. Note that the operation devices described as examples are only examples, and a button, a dial switch, a graphical user interface (GUI) switch, and the like may be mounted in the vehicle 1.

The outer condition acquisition unit 12 is configured to acquire outer conditions of the vehicle 1, for example, environmental information in the surroundings of the vehicle such as lanes of a traveling path and objects in the surroundings of the vehicle. The outer condition acquisition unit 12 includes various cameras (a monocular camera, a stereo camera, an infrared camera, and the like) and various radars (a millimeter wave radar, a microwave radar, a laser radar, and the like), for example. Also, it is possible to use a fusion sensor that merges information obtained by the cameras with information obtained by the radars.

The route information acquisition unit 13 includes a navigation device. The navigation device has a global navigation satellite system (GNSS) receiver, map information (navigation map), a touch panel-type display device that functions as a user interface, a speaker, a microphone, and the like. The navigation device specifies the position of the vehicle 1 using the GNSS receiver and derives a route from the position to a destination designated by a user. The route derived by the navigation device is stored as route information 144 in a storage unit 140. The position of the vehicle 1 may be specified or interpolated by an inertial navigation system (INS) using outputs of the travel state acquisition unit 14. Also, the navigation device provides guidance on the route to the destination using voice or navigation display when the vehicle control device 100 executes the manual driving mode. Note that the configuration for specifying the position of the vehicle 1 may be provided independently from the navigation device. Also, the navigation device may be realized as one function of a terminal device such as a smartphone or a tablet terminal that the user owns, for example. In this case, information is transmitted and received between the terminal device and the vehicle control device 100 in wireless or wired communication.

The travel state acquisition unit 14 is configured to acquire a current travel state of the vehicle 1. The travel state acquisition unit 14 includes a travel position acquisition unit 26, a vehicle speed acquisition unit 28, a yaw rate acquisition unit 30, a steering angle acquisition unit 32, and a travel trajectory acquisition unit 34.

The travel position acquisition unit 26 is configured to acquire the travel position of the vehicle 1 and the posture (travel direction) of the vehicle 1 as one example of a travel state. The travel position acquisition unit 26 includes various position measurement devices, for example, devices (a GPS receiver, a GNSS receiver, a beacon receiver, and the like) that receive electromagnetic waves transmitted from satellites and devices on streets and acquire position information (latitudes, longitudes, altitudes, coordinates, and the like), a gyro sensor, an acceleration sensor, and the like. The travel position of the vehicle 1 is measured with reference to a specific location of the vehicle 1.

The vehicle speed acquisition unit 28 is configured to acquire a velocity (vehicle speed) of the vehicle 1 as one example of a travel state. The vehicle speed acquisition unit 28 includes a speed sensor or the like provided at one or more wheels, for example.

The yaw rate acquisition unit 30 is configured to acquire a yaw rate of the vehicle 1 as one example of a travel state. The yaw rate acquisition unit 30 includes a yaw rate sensor or the like, for example.

The steering angle acquisition unit 32 is configured to acquire a steering angle as one example of a travel state. The steering angle acquisition unit 32 includes a steering angle sensor or the like provided at a steering shaft, for example. Here, a steering angle speed and a steering angle acceleration are also acquired on the basis of the acquired steering angle.

The travel trajectory acquisition unit 34 is configured to acquire information regarding an actual travel trajectory of the vehicle 1 (actual travel trajectory) as one example of a travel state. The actual travel trajectory includes a trajectory (track) through which the vehicle 1 has actually traveled and may include a trajectory through which the vehicle 1 is scheduled to travel from now, for example, an extension on the front side in the travel direction of the trajectory (track) through which the vehicle 1 has traveled. The travel trajectory acquisition unit 34 includes a memory. The memory stores position information regarding a sequence of a series of dots included in the actual travel trajectory. Also, the extension can be predicted using a computer or the like.

The accelerator opening sensor 71, the brake depression amount sensor 73, and the steering angle sensor 75 that are operation detection sensors output an accelerator opening degree, a brake depression amount, and a steering angle that are detection results to the vehicle control device 100.

The shift switch 80 is a switch that is operated by an occupant of the vehicle 1. The shift switch 80 receives an operation performed by the occupant and switches driving modes (for example, the automated driving mode and the manual driving mode) in response to content of the received operation. For example, the shift switch 80 generates a driving mode designation signal for designating a driving mode of the vehicle 1 from the content of the operation performed by the occupant and outputs the driving mode designation signal to the vehicle control device 100.

In addition, the vehicle 1 according to the embodiment includes a shift device 60 that is operated by the driver via a shift lever. Positions of the shift lever (not illustrated) in the shift device 60 include parking (P), reverse travel (R), neutral (N), forward travel in an automated gear change mode (normal mode) (D), forward travel in a sport mode (S), and the like, as illustrated in FIG. 1.

A shift position sensor 205 is provided in the vicinity of the shift device 60. The shift position sensor 205 detects the position of the shift lever operated by the driver. Information regarding the shift position detected by the shift position sensor 205 is input to the vehicle control device 100. Note that the information regarding the shift position detected by the shift position sensor 205 is output directly to the travel driving force output device 90 in the manual driving mode.

In addition, the vehicle 1 according to the embodiment includes a paddle switch 65 provided in the vicinity of the steering wheel 74. The paddle switch 65 is configured of a minus button 66 (− switch) for providing a shift-down command in a manual gear change mode during manual driving (manual driving mode) and a plus button 67 (+ switch) for providing a shift-up command in a manual gear change mode. In the manual gear change mode (manual mode) of the automated transmission TM in the manual driving mode, operation signals of the minus button 66 and the plus button 67 are output to the vehicle control device 100, and shift-up or shift-down of a gear range set by the automated transmission TM is performed in accordance with the travel states or the like of the vehicle 1. Note that if either the minus button 66 or the plus button 67 is operated by the driver using the paddle switch 65 when the automated gear change mode is changed when the position of the shift lever is in the D range or the S range, for example, during manual driving, the automated gear change mode is switched to the manual gear change mode (manual mode) in the embodiment.

The notification device 82 includes various devices capable of outputting information. The notification device 82 outputs information for promoting switching from the automated driving mode to the manual driving mode to the occupant of the vehicle 1, for example. As the notification device 82, at least one of a speaker, a vibrator, a display device, a light emitting device, and the like is used, for example.

The occupant identification unit 15 includes an in-vehicle camera capable of imaging the interior of the vehicle 1, for example. The in-vehicle camera may be a digital camera using a solid-state imaging element such as a CCD (Charge Coupled Device) or a CMOS (Complementary Metal Oxide Semiconductor), a near-infrared camera combined with a near-infrared light source, or the like. The vehicle control device 100 can acquire an image captured by the in-vehicle camera and identify the current driver of the vehicle 1 from an image of the face of the driver of the vehicle 1 included in the image.

The travel driving force output device 90 is an electronic control unit (ECU). The travel driving force output device 90 acquires a travel control command value output from the travel controller 120 and controls the power source, the automated transmission TM, and the like mounted on the vehicle 1 on the basis of the command value.

The steering device 92 includes an electric motor, for example. The electric motor causes force to act on a rack-and-pinion mechanism and changes an orientation of a steered wheel. The steering device 92 drives the electric motor and changes the orientation of the steered wheel in accordance with information input from the travel controller 120.

The brake device 94 is an electric servo brake device that includes a brake caliper, a cylinder that delivers a hydraulic pressure to the brake caliper, an electric motor that causes the cylinder to generate a hydraulic pressure, and a brake controller. The brake controller of the electric servo brake device controls the electric motor in accordance with information input from the travel controller 120 such that a brake torque that outputs brake force in accordance with a brake operation is output to each wheel. The electric servo brake device may include, as backup, a mechanism that delivers the hydraulic pressure generated through the operation of the brake pedal 72 to the cylinder via a master cylinder.

Note that the brake device 94 is not limited to the aforementioned electric servo brake device and may be an electronic control-type hydraulic brake device. The electronic control-type hydraulic brake device controls an actuator in accordance with information input from the travel controller 120 and delivers the hydraulic pressure of the master cylinder to the cylinder. Also, the brake device 94 may include a regenerative brake using a traveling motor in a case in which the travel driving force output device 90 includes the traveling motor.

Next, the vehicle control device 100 will be described. The vehicle control device 100 includes the automated driving controller 110, the travel controller 120, and the storage unit 140. The automated driving controller 110 includes a host vehicle position recognition unit 112, an external environment recognition unit 114, an action plan generation unit 116, a target travel state setting unit 118. The respective components of the automated driving controller 110 and a part or entirety of the travel controller 120 are realized by a processor such as a central processing unit (CPU) executing programs. Also, a part or entirety thereof may be realized by hardware such as large scale integration (LSI) or an application specific integrated circuit (ASIC). In addition, the storage unit 140 is realized by a read only memory (ROM), a random access memory (RAM), a hard disk drive (HDD), a flash memory, or the like. The programs executed by the processor may be stored in the storage unit 140 in advance or may be downloaded from an external device via in-vehicle Internet equipment or the like. Also, the programs may be installed on the storage unit 140 by a portable storage medium that stores the programs being attached to a drive device, which is not illustrated in the drawing. In addition, the vehicle control device 100 may be implemented by a plurality of computer devices in a distributed manner. In this manner, it is possible to realize various kinds of processing in the embodiment by causing the in-vehicle computer in the vehicle 1 to cooperate with the aforementioned hardware functional units and software such as programs.

The automated driving controller 110 performs control by switching the driving modes in accordance with a signal input from the shift switch 80. Although the driving modes include a driving mode in which acceleration and deceleration and steering of the vehicle 1 are automatically controlled (automated driving mode) and a driving mode in which acceleration and deceleration of the vehicle 1 are controlled on the basis of operations performed on the operation devices such as the accelerator pedal 70 and the brake pedal 72 and steering is controlled on the basis of operations performed on the operation devices such as the steering wheel 74 (manual driving mode), the driving modes are not limited thereto. As another driving mode, for example, a driving mode in which one of acceleration and deceleration and steering of the vehicle 1 is automatically controlled and the other is controlled on the basis of operations performed on the operation devices (semi-automated driving mode). Note that “automated driving” in the following description is assumed to include the semi-automated driving mode in addition to the aforementioned automated driving mode.

Note that the automated driving controller 110 may stop operations, and an input signal from the operation detection sensor may be output to the travel controller 120 or may be supplied directly to the travel driving force output device 90, the steering device 92, or the brake device 94 when the manual driving mode is performed.

The host vehicle position recognition unit 112 of the automated driving controller 110 recognizes a lane (travel lane) in which the vehicle 1 is traveling and a relative position of the vehicle 1 with respect to the travel lane on the basis of the map information 142 stored in the storage unit 140 and the information input from the outer condition acquisition unit 12, the route information acquisition unit 13, or the travel state acquisition unit 14. The map information 142 is map information that is more accurate than the navigation map that the route information acquisition unit 13 has and includes information regarding centers of lanes, information regarding boundaries of lanes, or the like, for example. More specifically, the map information 142 includes road information, traffic restriction information, address information (addresses, postal codes), facility information, telephone number information, and the like. The road information includes information representing types of roads such as highways, toll roads, national roads, prefectural roads, the numbers of lanes of the roads, widths of the lanes, gradients of roads, positions of roads, (three-dimensional coordinates including latitudes, longitudes, attitudes), curvatures of curves of lanes, positions of merging and branching points of lanes, traffic signs provided on roads, and the like. The traffic restriction information includes information regarding lane blockage due to construction, traffic accidents, traffic jams, and the like.

The host vehicle position recognition unit 112 recognizes, as the relative position of the vehicle 1 with respect to the travel lane, a distance between a reference point (a gravity center, for example) of the vehicle 1 and the center of the travel lane and an angle relative to a line connecting the center of the travel line in the travel direction of the vehicle 1, for example. Note that the host vehicle position recognition unit 112 may recognize, as the relative position of the vehicle 1 with respect to the travel lane, the position of the reference point of the vehicle 1 relative to any side end of the travel line.

The external environment recognition unit 114 recognizes states of vehicles in the surroundings, such as the positions, the speeds, and the acceleration on the basis of the information input from the outer condition acquisition unit 12 or the like. The vehicles in the surroundings according to the embodiment are other vehicles that travel in the surroundings of the vehicle 1 in the same direction as that of the vehicle 1. The positions of the vehicles in the surroundings may be represented by representative points such as the gravity center or corners of the vehicle 1 or may be represented by a region expressed with an outline of the vehicle 1. The “states” of the vehicles in the surroundings may include acceleration of the vehicles in the surroundings and whether or not the vehicles have experienced lance change (or whether or not the vehicles are trying to change lanes) on the basis of the information from the aforementioned various machines. Also, the external environment recognition unit 114 may recognize positions of a guard rails, poles, parked vehicles, pedestrians, and other objects in addition to the vehicles in the surroundings.

The action plan generation unit 116 sets an automated driving start point, an automated driving end scheduled point, and/or an automated driving destination. The automated driving start point may be a current position of the vehicle 1 or may be a point at which an operation of providing a command for automated driving is provided by the occupant of the vehicle 1. The action plan generation unit 116 generates an action plan in a section between the start point and the end scheduled point or in a section between the start point and the automated driving destination. Note that the disclosure is not limited thereto and the action plan generation unit 116 may generate the action plan in any section.

The action plan is configured of a plurality of events that are executed in order, for example. The events include a deceleration event of decelerating the vehicle 1, an acceleration event of accelerating the vehicle 1, a lane keeping event of causing the vehicle 1 to travel without departing from the travel lane, a lane change event of causing the vehicle 1 to change the travel lane, a overtaking event of causing the vehicle 1 to overtake a vehicle traveling in front of the vehicle 1, a branching event of causing the vehicle 1 to change a lane to a desired lane at a branching point or causing the vehicle 1 to travel without departing from the current travel lane, and a merging event of causing the vehicle 1 to accelerate or decelerate in the merging lane for merging with a main lane and change the travel lane, for example.

In a case in which a toll road (for example, a highway) includes a junction (branching point), for example, the vehicle control device 100 changes lanes or keep traveling on the same lane such that the vehicle 1 advances in the direction to the destination. Therefore, in a case in which it is determined that there is a junction on a road with reference to the map information 142, the action plan generation unit 116 sets a lane change event to change the lane to a desired lane along which the vehicle 1 can advance in the direction to the destination from the current position (coordinates) of the vehicle 1 to the position of the junction (coordinates). Note that the information indicating the action plan generated by the action plan generation unit 116 is stored as action plan information 146 in the storage unit 140.

The target travel state setting unit 118 is configured to set a target travel state that is a travel state targeted by the vehicle 1 on the basis of the action plan decided by the action plan generation unit 116 and the various kinds of information acquired by the outer condition acquisition unit 12, the route information acquisition unit 13, and the travel state acquisition unit 14. The target travel state setting unit 118 includes a target value setting unit 52 and a target trajectory setting unit 54. Also, the target travel state setting unit 118 includes a deviation acquisition unit 42 and a correction unit 44.

The target value setting unit 52 is configured to set information regarding a travel position (latitudes, longitudes, attitudes, coordinates, and the like) targeted by the vehicle 1 (also simply referred to as a target position), a target vehicle speed value information (also simply referred to as a target vehicle speed), and target yaw rate value information (also simply referred to as a target yaw rate). The target trajectory setting unit 54 is configured to set target trajectory information of the vehicle 1 (also simply referred to as a target trajectory) on the basis of the outer conditions acquired by the outer condition acquisition unit 12 and travel route information acquired by the route information acquisition unit 13. The target trajectory includes information regarding a target position of each unit time. Each target position is associated with posture information (travel direction) of the vehicle 1. Also, each target position may be associated with target value information such as a vehicle speed, acceleration, a yaw rate, lateral G force, a steering angle, and a steering angular acceleration. The aforementioned target position, target vehicle speed, target yaw rate, and target trajectory are information indicating the target travel state.

The deviation acquisition unit 42 is configured to acquire deviation of an actual travel state with respect to the target travel state on the basis of the target travel state set by the target travel state setting unit 118 and the actual travel state acquired by the travel state acquisition unit 14.

The correction unit 44 is configured to correct the target travel state in accordance with the deviation acquired by the deviation acquisition unit 42. Specifically, a new target travel state is set by causing the target travel state set by the target travel state setting unit 118 to further approach the actual travel state acquired by the travel state acquisition unit 14 as the deviation increases.

The travel controller 120 is configured to control traveling of the vehicle 1. Specifically, the travel controller 120 outputs a command value for travel control such that the travel state of the vehicle 1 coincides with or approaches the target travel state set by the target travel state setting unit 118 or the new target travel state set by the correction unit 44. The travel controller 120 includes an acceleration and deceleration command unit 56 and a steering command unit 58.

The acceleration and deceleration command unit 56 is configured to control acceleration and deceleration in the travel control for the vehicle 1. Specifically, the acceleration and deceleration command unit 56 arithmetically operates an acceleration and deceleration command value for causing the travel state of the vehicle 1 to coincide with the target travel state on the basis of the target travel state (target acceleration and deceleration) set by the target travel state setting unit 118 or the correction unit 44 and the actual travel state (actual acceleration or deceleration).

The steering command unit 58 is configured to control steering in the travel control for the vehicle 1. Specifically, the steering command unit 58 arithmetically operates a steering angular speed command value for causing the travel state of the vehicle 1 to coincide with the target travel state on the basis of the target travel state set by the target travel state setting unit 118 or the correction unit 44 and the actual travel state.

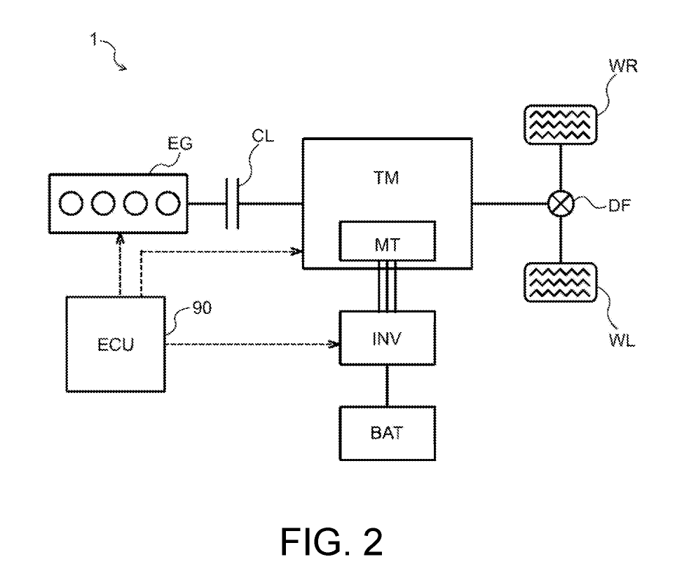

A hybrid vehicle will be described as an example of the vehicle 1 to which the vehicle control device 100 can be applied with reference to FIG. 2. FIG. 2 is an outline diagram illustrating a configuration of a hybrid vehicle. As illustrated in FIG. 2, the vehicle 1 that is a hybrid vehicle includes an engine EG (internal combustion engine) and a motor MT (electric motor) as power sources. The vehicle 1 further includes an inverter INV for controlling the motor MT, a battery BAT (condenser), an automated transmission TM (transmission), a differential mechanism DF, and right and left drive wheels WR and WL. The motor MT includes a motor generator, and the battery BAT includes a capacitor. Also, the engine EG includes a diesel engine, a turbo engine, or the like. Rotation driving force of the engine EG and the motor MT is delivered to the right and left drive wheels WR and WL via the automated transmission TM and the differential mechanism DF. Also, the vehicle 1 has a clutch CL. The power is delivered from the engine EG to the automated transmission TM by fastening the clutch CL. Therefore, the clutch CL can connect and disconnect the power transmission between the engine EG and the automated transmission TM. The engine EG, the motor MT, and the automated transmission TM are controlled by the travel driving force output device 90.

With this configuration, the travel driving force output device 90 that has received a command from the vehicle control device 100 performs control such that motor independent travel (EV (Electric Vehicle) travel) using only the motor MT as a power source is performed, performs control such that engine independent travel using only the engine EG as a power source is performed, or performs control such that cooperative travel (HEV (Hybrid Electric Vehicle) travel) using both the engine EG and the motor MT as power sources is performed in accordance with various driving conditions.

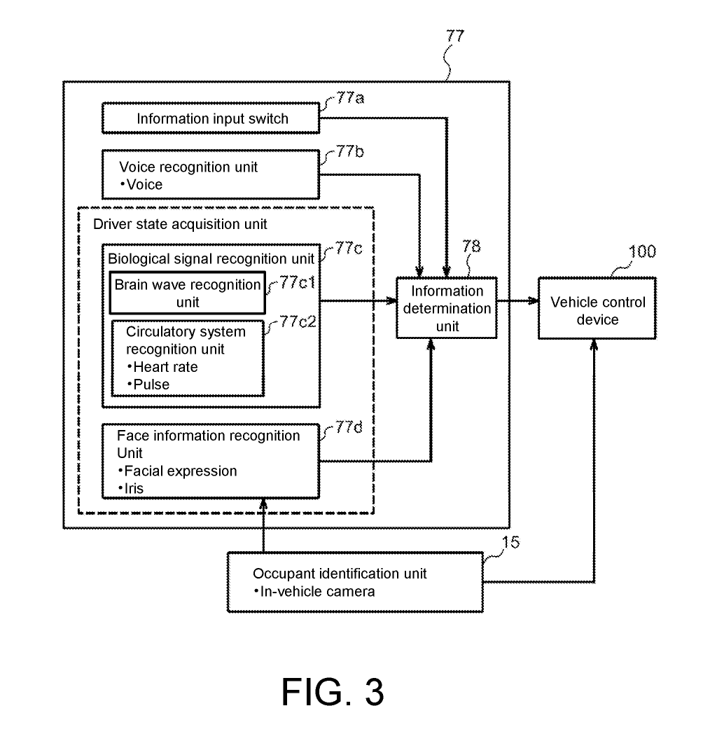

An occupant information acquisition unit 77 that acquires a degree to which the occupant is in a hurry according to the embodiment will be described with reference to FIG. 3. The occupant information acquisition unit 77 is mounted on the vehicle 1. FIG. 3 is an outline explanatory diagram of the occupant information acquisition unit 77 according to the embodiment. As illustrated in FIG. 3, the vehicle control device 100 according to the embodiment is provided with the occupant information acquisition unit 77 (information acquisition unit) that acquires a state in which the driver is in a hurry. The occupant information acquisition unit 77 has an information determination unit 78 that determines whether or not the driver is in a hurry, and in a case in which it is determined that the driver is in a hurry, the information determination unit 78 delivers the state in which the driver is in a hurry to the vehicle control device 100. The occupant information acquisition unit 77 acquires the state in which the driver is in a hurry with the following mechanism as described below.

First, the occupant information acquisition unit 77 has an information input switch 77a (input switch) and a voice recognition unit 77b that serve as components for acquiring the state in which the driver is in a hurry in accordance with a driver's input action. The information input switch 77a may be in the form of a button or a lever, and the driver himself/herself operates (performs input action) the information input switch 77a in a case in which the driver is in a hurry. Also, the voice recognition unit 77b may be any voice recognition unit such as a microphone as long as it recognizes sound such as driver's voice and recognizes the state in which the driver is in a hurry in accordance with command (input action) provided by driver's voice.

In addition, the occupant information acquisition unit 77 has a driver state acquisition unit that acquires the state in which the driver is in a hurry without any need of the driver's input action. As the driver state acquisition unit, there are a biological signal recognition unit 77c and a face information recognition unit 77d. The biological signal recognition unit 77c has devices capable of acquiring biological signals such as a brain wave recognition unit 77c1 that recognizes brain waves and a circulatory system recognition unit 77c2 capable of acquiring information regarding a heart rate and a pulse. In addition, the face information recognition unit 77d analyzes information such as a facial expression or irises of the driver from the in-vehicle camera that the aforementioned occupant identification unit 15 has and acquires whether or not the driver is in a hurry.

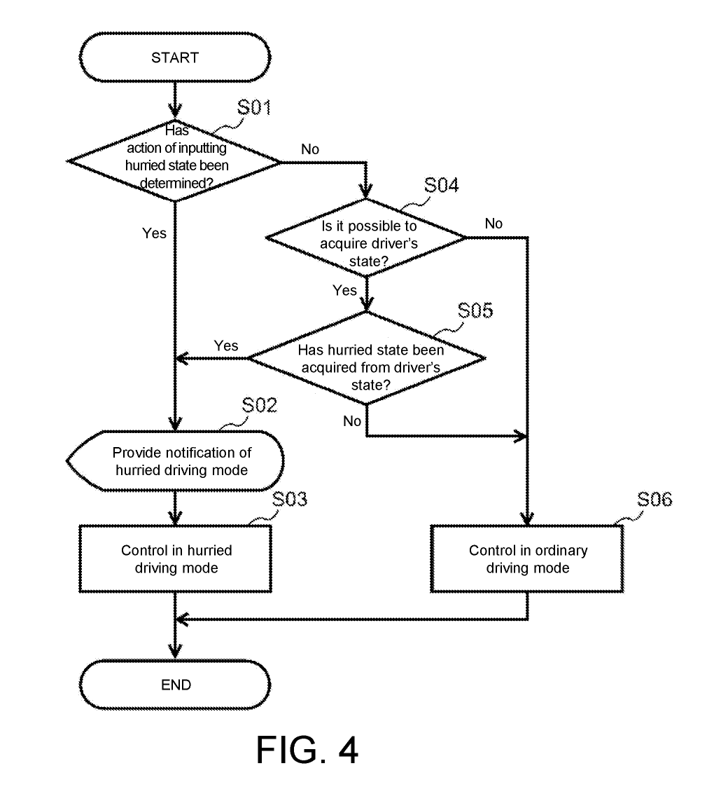

Control performed in a case in which the automated driving controller 110 switches between the ordinary driving mode and the hurried driving mode will be described with reference to FIG. 4. The action plan generation unit 116 of the automated driving controller 110 can select the ordinary driving mode and the hurried driving mode that is used in a state in which the driver is in a hurry. The hurried driving mode is a mode in which the vehicle can arrive at the destination earlier than in the ordinary driving mode, and in the mode, a state in which the driver is in a hurry appears in behaviors of the vehicle. FIG. 4 is a flowchart for describing control of the ordinary driving mode and the hurried driving mode.

In the automated driving mode, it is determined whether or not the driver has performed an input action in relation to the state in which the driver is in a hurry (represented as “hurried state” in the drawing) (Step S01).

In a case in which there has been an input action through an operation of the aforementioned information input switch 77a or a voice command provided to the voice recognition unit 77b in Step S01, the driver is notified of the switching to the hurried driving mode (Step S02), and control in the hurried driving mode is performed (Step S03). The notification is provided to the driver by the aforementioned notification device 82. Note that either Step S02 or Step S03 may be performed first.

Meanwhile, in a case in which there has not been a driver's input action in Step S01, whether or not it is possible to acquire the driver's state is determined by the driver state acquisition unit of the occupant information acquisition unit 77 (Step S04).

In a case in which it is possible to acquire the driver's state in Step S04, whether or not the state in which the driver is in a hurry has been acquired is determined (Step S05). In a case in which the state in which the driver is in a hurry has been acquired, notification of the hurried driving mode and control in the hurried driving mode are performed (Step S02 and Step S03).

Meanwhile, in a case in which it is not possible to acquire the driver's state in Step S04, or in a case in which the state in which the driver is in a hurry has not been acquired in Step S05, control in the ordinary driving mode is performed (Step S06).

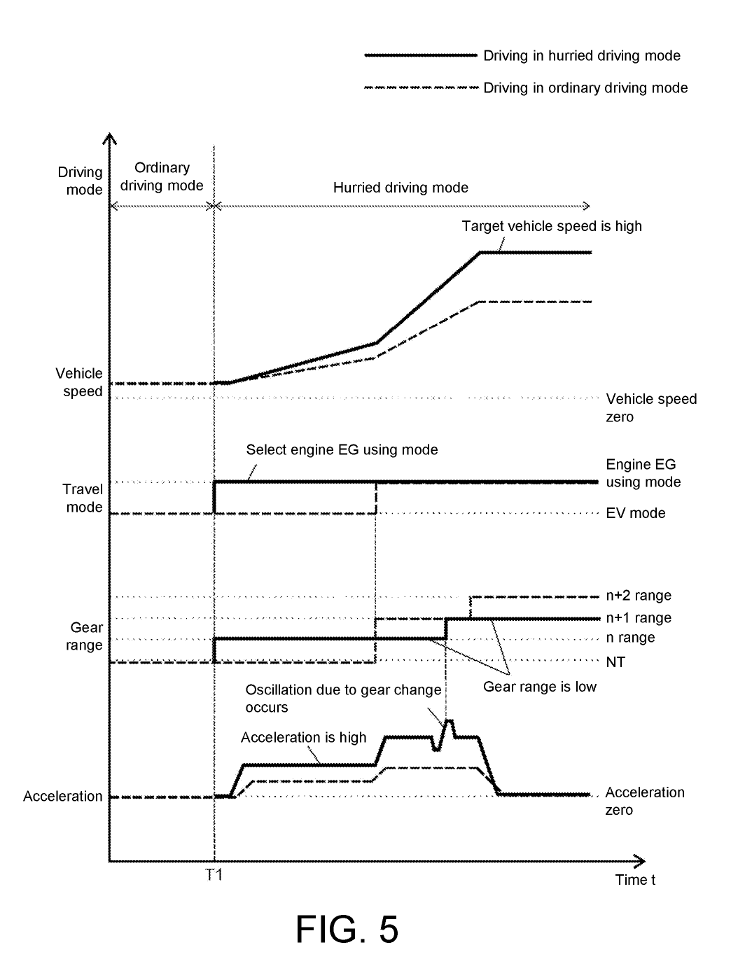

Next, a specific example of the hurried driving mode selected by the automated driving controller 110 will be described with reference to drawings. First, examples related to a vehicle speed and acceleration and deceleration in the hurried driving mode will be described. In the timing chart, the hurried driving mode and the ordinary driving mode are compared with each other. FIG. 5 illustrates a case in which the ordinary driving mode shifts to the hurried driving mode at a clock time T1. Also, in the drawing, a driving state in the hurried driving mode and a driving state in a case in which the ordinary driving mode is continued as it is are compared in an overlaid manner at and after the clock time T1. Note that the following entire hurried driving mode is not necessarily executed as the hurried driving mode, and at least any part of the hurried driving mode may be executed.

As illustrated in FIG. 5, the hurried driving mode is set such that the acceleration is higher than that in the ordinary driving mode. Specifically, the acceleration is set to be higher than that in the ordinary driving mode when the action plan generation unit 116 of the automated driving controller 110 generates an acceleration event of accelerating the vehicle 1. In this manner, an acceleration command value that the acceleration and deceleration command unit 56 of the travel controller 120 delivers to the travel driving force output device 90 increases.

In addition, the hurried driving mode is set such that a transmission ratio is higher than that in the ordinary driving mode. Specifically, control is performed such that a relatively lower gear range than that in the ordinary driving mode is selected in the hurried driving mode when the action plan generation unit 116 generates a gear change event of selecting the gear range of the automated transmission TM of the vehicle 1.

In addition, the hurried driving mode is set such that a time required for gear change is shorter than that in the ordinary driving mode. Further, the hurried driving mode is set such that more oscillation occurs during the gear change than in the ordinary driving mode. Specifically, the time required for gear change is set to be shorter when the action plan generation unit 116 generates a gear change event. Also, occurrence of oscillation during gear change is allowed at the time of the gear change.

In addition, a target vehicle speed in the hurried driving mode is set be higher than that in the ordinary driving mode. Specifically, the target vehicle speed is set to be higher when the action plan generation unit 116 generates an acceleration event of the vehicle 1. In this manner, a vehicle speed command value that the acceleration and deceleration command unit 56 of the travel controller 120 delivers to the travel driving force output device 90 increases.

In addition, the hurried driving mode is set such that stopping of the engine EG is inhibited. Therefore, the engine EG is necessarily used as the power source when the action plan generation unit 116 generates the action plan. Thus, the travel driving force output device 90 selects a mode in which the engine EG is used (the engine independent travel mode or the HEV travel mode) as a power source in response to a command from the travel controller 120.

Also, the hurried driving mode is set such that more power is generated by the motor MT than in the ordinary driving mode. That is, power of the motor MT may be added to the power of the engine EG when the mode in which the engine EG is used is executed in a hybrid vehicle. In this case, the action plan generation unit 116 generates an action plan according to which the motor MT is caused to generate more power in the hurried driving mode than in the ordinary driving mode. In this manner, more power is generated in the hurried driving mode than in the ordinary driving mode.

Next, an example related to an action plan will be described from among specific examples of the hurried driving mode. In an example of the hurried driving mode related to the action plan, the hurried driving mode is set such that an inter-vehicle distance is shorter than that in the ordinary driving mode. Specifically, the action plan generation unit 116 sets the distance (inter-vehicle distance) between the vehicle traveling in front of the vehicle 1 obtained by the external environment recognition unit 114 and the host vehicle obtained by the host vehicle position recognition unit 112 to be shorter in the hurried driving mode than in the ordinary driving mode.

Also, the hurried driving mode is set such that a time required for lane change is shorter than that in the ordinary driving mode. Specifically, in a case in which the action plan generation unit 116 sets a time required for lane change in a lane change event of causing the vehicle 1 to change the travel lane, the action plan generation unit 116 sets the time required for lane change to be shorter in the hurried driving mode than in the ordinary driving mode.

Also, the hurried driving mode is set such that a route for an earlier destination arrival time than in the ordinary driving mode is selected. Specifically, a route to the destination is derived using the navigation device of the route information acquisition unit 13, and the action plan generation unit 116 selects the shortest route to the destination in the route information 144 stored in the storage unit 140.

As described above, according to the vehicle control device 100 in the embodiment, it is possible to arrive at the destination early by the action plan generation unit 116 of the automated driving controller 110 selecting the hurried driving mode in a case in which the state in which the driver is in a hurry is acquired. Also, since the state in which the driver is in a hurry appears in the behaviors of the vehicle, it is possible for the driver to recognize that the vehicle is being able to travel as the driver intends from the behaviors of the vehicle.

In addition, the hurried driving mode is set such that acceleration is higher than that in the ordinary driving mode. In this manner, the state in which the user is in a hurry appears in the behaviors of the vehicle, and it is possible to arrive at the destination early.

Also, the hurried driving mode is set such that a transmission ration is higher than that in the ordinary driving mode. In this manner, the state in which the user is in a hurry appears in the behaviors of the vehicle, and it is possible to immediately respond to an acceleration request.

In addition, the hurried driving mode is set such that a time required for gear change is shorter than that in the ordinary driving mode. In this manner, the state in which the user is in a hurry appears in the behaviors of the vehicle, and it is possible to shorten the time required for gear change.

In addition, the hurried driving mode is set such that more oscillation occurs during gear change than in the ordinary driving mode. In this manner, the state in which the user is in a hurry appears in the behaviors of the vehicle.

In addition, the hurried driving mode is set such that a target vehicle speed is higher than that in the ordinary driving mode. In this manner, the state in which the user is in a hurry appears in the behaviors of the vehicle, and it is possible to arrive at the destination early.

In addition, the hurried driving mode is set such that an inter-vehicle distance is shorter than that in the ordinary driving mode. In this manner, the state in which the user is in a hurry appears in the behaviors of the vehicle, this leads to a decrease in time at a traffic signal and the like, for example, and it is thus possible to arrive at the destination early.

In addition, the hurried driving mode is set such that the time required for lane change is shorter than that in the ordinary driving mode. In this manner, the state in which the user is in a hurry appears in the behaviors of the vehicle.

In addition, the hurried driving mode is set such that a route for an earlier destination arrival time than in the ordinary driving mode is selected. In this manner, arrival at the destination becomes earlier.

In addition, the vehicle 1 has the engine EG and the motor MT as power sources, and the hurried driving mode is set such that stopping of the engine EG is inhibited. In this manner, the state in which the user is in a hurry appears in the behaviors of the vehicle, and it is possible to obtain a state in which the maximum driving force can be output using the engine EG in a hybrid vehicle.

In addition, the hurried driving mode is set such that more power is generated by the motor MT than in the ordinary driving mode. In this manner, more power is output, and arrival at the destination becomes earlier.

In addition, the occupant information acquisition unit 77 acquires the state in which the driver is in a hurry on the basis of a driver's input action. In this manner, it is possible to reliably deliver the state in which the driver is in a hurry to the information acquisition unit.

In addition, the occupant information acquisition unit 77 has the information input switch 77a for inputting the state in which the driver is in a hurry, and an input action is performed by the driver operating the information input switch 77a. In this manner, it is possible to reliably deliver the state in which the driver is in a hurry to the information acquisition unit with a simple operation, namely an operation of the switch.

In addition, the occupant information acquisition unit 77 has the voice recognition unit 77b capable of recognizing voice, and the input action is performed by driver's voice being recognized by the voice recognition unit 77b. In this manner, it is possible to reliably deliver the state in which the driver is in a hurry to the occupant information acquisition unit 77 with a simple driver's operation, namely voice generation.

In addition, the occupant information acquisition unit 77 has the biological signal recognition unit 77c and the face information recognition unit 77d that serve as the driver state acquisition unit capable of acquiring the state in which the driver is in a hurry. If the driver state acquisition unit is provided in this manner, it is possible to omit the driver's input action by automatically acquiring the state in which the driver is in a hurry.

In addition, the driver state acquisition unit has the biological signal recognition unit 77c capable of acquiring biological signals of the driver. It is possible to omit the driver's input action by acquiring the biological signals in this manner.

In addition, the driver state acquisition unit has the face information recognition unit 77d capable of acquiring a facial expression of the driver. It is possible to omit the driver's input action by acquiring the facial expression in this manner.

In addition, the vehicle 1 has the notification device 82 for notifying the driver of information, and the automated driving controller 110 provides a notification to the notification device 82 in a case in which the occupant information acquisition unit 77 has acquired the state in which the driver is in a hurry. In this manner, it is possible for the driver to easily recognize that the vehicle 1 is being able to travel as the driver intends in the case of the state in which the driver is in a hurry.

Although the embodiment of the disclosure has been described above, the disclosure is not limited to the aforementioned embodiment, and various modifications can be made within the scope of the claims and the scope of the technical ideas described in the specification and the drawings.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A vehicle control device, capable of performing a switching between an automated driving mode and a manual driving mode, wherein in the automated driving mode steering, acceleration and deceleration of a vehicle are automatically controlled and in the manual driving mode steering, acceleration and deceleration of the vehicle are controlled based on a driver's operation, the vehicle control device comprising:
an automated driving controller that decides an action plan,
wherein the automated driving controller is selectable between an ordinary driving mode and a hurried driving mode in which the hurried driving mode is used in a case in which the driver is in a hurry as compared with the ordinary driving mode,
the hurried driving mode is a mode in which the vehicle is able to arrive at a destination earlier than in the ordinary driving mode and in which a state in which the driver is in a hurry appears in behaviors of the vehicle,
the vehicle is provided with an information acquisition unit that acquires the state in which the driver is in a hurry and delivers information to the automated driving controller, and
the automated driving controller selects the hurried driving mode in a case in which the information acquisition unit acquires the state in which the driver is in a hurry.

2. The vehicle control device according to claim 1, wherein the hurried driving mode is set such that acceleration is higher than acceleration in the ordinary driving mode.

3. The vehicle control device according to claim 1, wherein the hurried driving mode is set such that a transmission ratio is higher than a transmission ratio in the ordinary driving mode.

4. The vehicle control device according to claim 1, wherein the hurried driving mode is set such that a time required for gear change is shorter than a time required for gear change in the ordinary driving mode.

5. The vehicle control device according to claim 1, wherein the hurried driving mode is set such that more oscillation occurs during gear change than in the ordinary driving mode.

6. The vehicle control device according to claim 1, wherein the hurried driving mode is set such that a target vehicle speed is higher than a target vehicle speed in the ordinary driving mode.

7. The vehicle control device according to claim 1, wherein the hurried driving mode is set such that an inter-vehicle distance is shorter than an inter-vehicle distance in the ordinary driving mode.

8. The vehicle control device according to claim 1, wherein the hurried driving mode is set such that a time required for lane change is shorter than a time required for lane change in the ordinary driving mode.

9. The vehicle control device according to claim 1, wherein the hurried driving mode is set such that a route for an earlier destination arrival time than in the ordinary driving mode is selected.

10. The vehicle control device according to claim 1,
wherein the vehicle has an internal combustion engine and an electric motor that serve as power sources, and
the hurried driving mode is set such that stopping of the internal combustion engine is inhibited.

11. The vehicle control device according to claim 10, wherein the hurried driving mode is set such that the electric motor is caused to generate more power than in the ordinary driving mode.

12. The vehicle control device according to claim 1, wherein the information acquisition unit acquires a state in which the driver is in a hurry based on an input action input by the driver.

13. The vehicle control device according to claim 12,
wherein the information acquisition unit has an input switch for inputting the state in which the driver is in a hurry, and
the input action is performed by the driver operating the input switch.

14. The vehicle control device according to claim 13,
wherein the information acquisition unit has a voice recognition unit that is able to recognize voice, and
the input action is performed by voice of the driver being recognized using the voice recognition unit.

15. The vehicle control device according to claim 1,
wherein the information acquisition unit has a driver state acquisition unit that is able to acquire a state in which the driver is in a hurry.

16. The vehicle control device according to claim 15, wherein the driver state acquisition unit is a biological signal recognition unit that is able to acquire a biological signal of the driver.

17. The vehicle control device according to claim 16, wherein the driver state acquisition unit is a face information recognition unit that is able to acquire a facial expression of the driver.

18. The vehicle control device according to claim 1,
wherein the vehicle has a notification device that notifies the driver of information, and
the automated driving controller provides a notification to the notification device in a case in which the information acquisition unit acquires a state in which the driver is in a hurry.

19. The vehicle control device according to claim 12,
wherein the information acquisition unit has a voice recognition unit that is able to recognize voice, and
the input action is performed by voice of the driver being recognized using the voice recognition unit.

20. The vehicle control device according to claim 15, wherein the driver state acquisition unit is a face information recognition unit that is able to acquire a facial expression of the driver.
